(19) United States
(12) Patent Application Publication
(10) Pub. No.: US 2010/0050648 A1
(43) Pub. Date: Mar. 4, 2010

(54) COMBUSTOR AND THE METHOD OF FUEL SUPPLY AND CONVERTING FUEL NOZZLE

(75) Inventors: Keisuke MIURA, Mito (JP); Satoshi Dodo, Kasama (JP); Kazuhito KOYAMA, Hitachi (JP); Tomomi KOGANEZAWA, Tokai (JP); Hiromi KOIZUMI, Hitachi (JP)

Correspondence Address: FOLEY AND LARDNER LLP;SUITE 500, 3000 K STREET NW, WASHINGTON, DC, 20007, US

(73) Assignee: Hitachi, Ltd.

(21) Appl. No.: 12/538,646

(22) Filed: Aug. 10, 2009

(30) Foreign Application Priority Data
Sep. 3, 2008 (JP) 2008-225433

(51) Int. Cl. F02C 7/22

(52) U.S. Cl. 60/748

(57) ABSTRACT

An object of this invention is to accelerate further mixing of a fuel and air independently of a flow rate of the fuel.

A gas turbine combustor comprises: a fuel nozzle for blowing out a gas fuel; an air nozzle plate with an air nozzle for jetting out the fuel and air into a combustion chamber after the blowout of the fuel from the fuel nozzle; and an obstacle formed inside the air nozzle; wherein the obstacle causes a collision of the fuel jet blown out from the fuel nozzle, and hence causes turbulence in an airflow streaming into the air nozzle.

According to the invention, mixing between the fuel and the air can be further accelerated independently of the flow rate of the fuel.

### BACKGROUND OF THE INVENTION

1. Field of the Invention

The present invention relates to a combustor, a method of supplying a fuel to the combustor, and a method of converting fuel nozzles in the combustor.

2. Description of the Related Art

Gas turbine combustors employ either diffusion burner or premix burner. In the diffusion burner, because of the high turn-down ratio from the startup of the combustor to the start of operation under rated load conditions, a fuel is injected into the combustion chamber directly to ensure the stability of combustion in a wide range. Premix burner, on the other hand, can reduce nitrogen oxides (NOx). The premix burner has had the problem that the entry of flames into the premixer causes a backfire resulting in thermal damage to the structure.

JP-A-2003-148734, for example, describes a technique for arranging fuel nozzles and air nozzle plates at the upstream side of a combustion chamber and supplying fuel and air as coaxial flow to the chamber in order to avoid the above problem.

### SUMMARY OF THE INVENTION

Regulations and social demands relating to the environment have been increasing each day and further reduction of NOx has been a problem even in the combustor structure disclosed in JP-A-2003-148734.

In addition, in the combustor structure of JP-A-2003-148734, a fuel jet with a momentum is blown out into each air nozzle. Accordingly, under high-fuel-flow rate conditions, in particular, the fuel jet has penetrated the turbulent flow region of an air flow formed at the fuel nozzle exit, and generated an insufficient fuel-air mixture.

An object of the present invention is to accelerate further mixing of a fuel and air independently of a flow rate of the fuel.

The present invention provides a gas turbine combustor comprising: a fuel nozzle for blowing out a gas fuel; an air nozzle plate with an air nozzle for jetting out the fuel and air into a combustion chamber after the blowout of the fuel from the fuel nozzle; and an obstacle formed inside the air nozzle; wherein the obstacle causes a collision of the fuel jet blown out from the fuel nozzle, and hence causes turbulence in an airflow streaming into the air nozzle.

According to the present invention, further fuel-air mixing can be accelerated independently of a flow rate of the fuel.

### BRIEF DESCRIPTION OF THE DRAWINGS

FIG. 1 is a sectional view showing a fuel nozzle, air nozzle, and obstacle in a first embodiment, a relationship in position between the three members, and flows of an airflow and a fuel jet;

FIG. 2 is a front view of the air nozzle as viewed from a downstream end thereof in the first embodiment;

FIG. 3 is a sectional view showing the fuel nozzle, air nozzle, obstacle, and support member in the first embodiment, a relationship in position between the four members, and flows of the airflow and the fuel jet;

FIG. 4 is a sectional view of the air nozzle and support member in the first embodiment;

FIG. 5 is a sectional view showing a configurational example of the air nozzle, air nozzle plate, obstacle, and support member in the first embodiment;

FIG. 6 is a sectional view showing another configurational example of the obstacle and support member in the first embodiment;

FIGS. 7A and 7B are a sectional view and a front view showing an example of air nozzle plate fabrication and grooving in the first embodiment, respectively;

FIG. 8 is a sectional view showing yet another configurational example of the air nozzle, air nozzle plate, obstacle, and support member in the first embodiment;

FIGS. 9A and 9B are a sectional view and a rear view showing another example of air nozzle plate fabrication and grooving in the first embodiment, respectively;

FIGS. 10A to 10C are sectional views showing an example of a cross-sectional shape of the support member in the first embodiment;

FIGS. 11A and 11B are diagrams showing an example of a method of supporting the obstacle in the first embodiment and a further configurational example of the obstacle and the support member;

FIG. 12 is a diagram showing another example of a method of supporting the obstacle in the first embodiment;

FIGS. 13A and 13B are diagram showing a variation on a shape of the obstacle in the first embodiment and an occurrence state of longitudinal vortices;

FIGS. 14A and 14B are diagrams showing another variation on the shape of the obstacle in the first embodiment;

FIG. 15 is a sectional view showing a fuel nozzle, air nozzle, and obstacle in a second embodiment, a relationship in position between the three members, and flows of an airflow and a fuel jet;

FIG. 16 is an enlarged view of the fuel nozzle tip and obstacle in the second embodiment;

FIG. 17 is a sectional view showing the fuel nozzle, air nozzle, and obstacle under a misaligned state of central axes of the fuel nozzle and air nozzle, an example of a relationship in position between the three members under the misaligned state, and associated flows of the airflows and fuel jet;

FIG. 18 is a sectional view showing a fuel nozzle, air nozzle, and obstacle in a third embodiment, a relationship in position between the three members, and flows of an airflow and a fuel jet;

FIG. 19 is a sectional view showing a fuel nozzle, air nozzle, and obstacle in a fourth embodiment, a relationship in position between the three members, and flows of an airflow and a fuel jet;

FIG. 20 is a front view of an air nozzle and obstacle in a fifth embodiment;

FIGS. 21A and 21B are front views showing an example of an air nozzle and obstacle in the fifth embodiment;

FIG. 22 is an enlarged view showing a flow of an airflow passing through a corner of the obstacle in the fifth embodiment;

FIG. 23 is a sectional view showing a fuel nozzle, air nozzle, and obstacle in a sixth embodiment, a relationship in position between the three members, and flows of an airflow and a fuel jet;

FIGS. 24A and 24B are a front view of the air nozzle and obstacle in the sixth embodiment and a sectional view showing the air nozzle, a support member, and the fuel nozzle, respectively;

FIG. 25 is a sectional view showing the fuel nozzle, air nozzle, obstacle, and support member in the sixth embodiment, the relationship in position between the four members, and the flows of the airflow and the fuel jet;

FIG. 26 is a front view of the air nozzle and obstacle in a seventh embodiment;

FIG. 27 is a sectional view showing a fuel nozzle, air nozzle, and obstacle in an eighth embodiment, a relationship in position between the three members, and flows of an airflow and a fuel jet;

FIG. 28 is a front view of the air nozzle, obstacle, and support member in the eighth embodiment;

FIG. 29 is a sectional view showing a fuel nozzle and air nozzle in a comparative example, and an example of flows of an airflow and a fuel jet;

FIGS. 30A and 30B show an example of fabricating the fuel nozzle, obstacle, and support member in the sixth embodiment; and

FIG. 31 is a schematic diagram of an entire gas turbine combustor.

### DESCRIPTION OF THE PREFERRED EMBODIMENTS

Embodiments of the present invention are described below.

### First Embodiment

FIG. 31 shows a sectional view of an entire gas turbine combustor according to an embodiment. After being compressed by a compressor 5, air 10 flows into the combustor 100 through a diffuser 7 and moves past between an outer casing 2 and a combustor liner 3. Part of the air 10 flows into a chamber 1 as cooling air 11 for the combustor liner 3. A remainder of the air 10 flows through air nozzles 21 as an airflow 12 and flows into the chamber 1. An air nozzle plate 20 with each air nozzle 21 connected thereto is disposed between the chamber 1 and fuel nozzles 22.

Fuel supply lines 15 and 16 are divided from a fuel supply line 14 having a control valve 14a. Also, the fuel supply line 15 includes a control valve 15a and the fuel supply line 16 has a control valve 16a, and the two supply lines can each conduct independent control. In addition, the fuel supply lines 15 and 16 have cutoff valves 15b and 16b, downstream with respect to the respective control valves.

As shown in the figure, the combustor of the present embodiment has the plurality of fuel nozzles 22. The fuel nozzles 22 are connected to a fuel header 23 that distributes a fuel to each of the fuel nozzles. The fuel header 23 is internally segmented into a plurality of rooms to divide the fuel nozzles according to group. The fuel from the fuel supply lines 15 and 16 flows into the rooms of the fuel header 23 and is supplied to the fuel nozzle groups. Since the fuel supply lines each includes a control valve, these supply lines can control part of the multiple fuel nozzles 22 collectively. The fuel, after being blown out from each fuel nozzle 22, flows with the airflow 12 into the chamber 1 as a coaxial flow, thus forming a homogenous and stable flame. A hot combustion gas that has thus been generated enters a turbine 6, then performs work in the turbine 6, and is discharged therefrom.

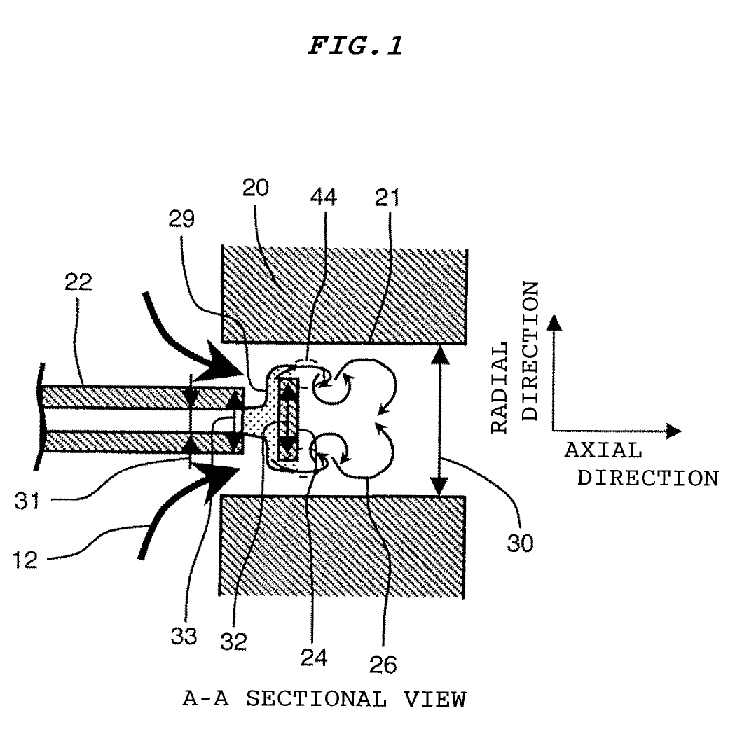

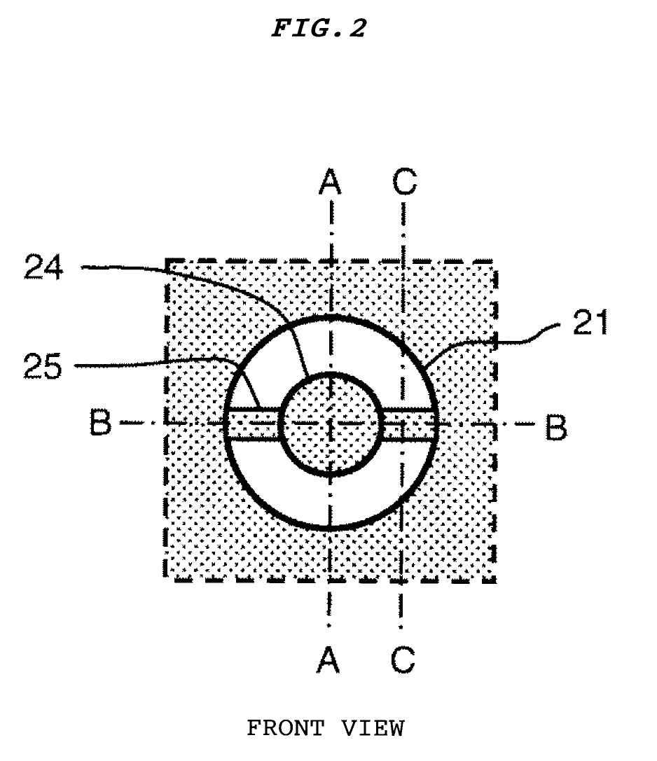

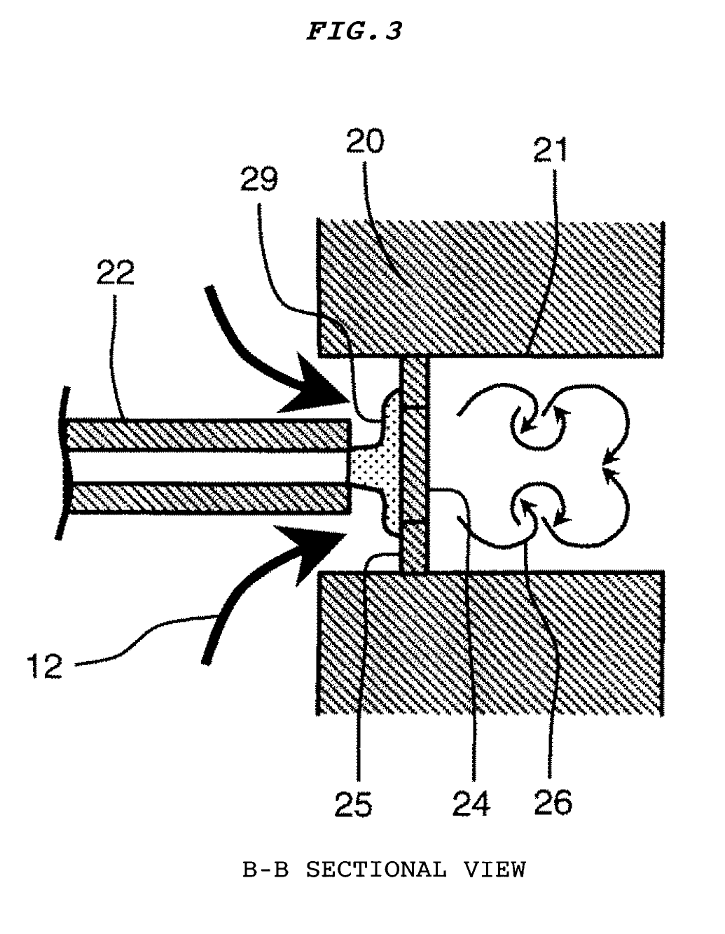

FIGS. 1 to 4 show details of the fuel nozzle 22 and the air nozzle 21. FIG. 2 is a front view of the fuel and air nozzles as viewed in an upstream direction from the chamber 1 disposed downstream in an axial direction. FIG. 1 is a sectional view taken along line A-A in FIG. 2. FIG. 3 is a sectional view taken along line B-B, and FIG. 4 is a sectional view taken along line C-C in FIG. 2.

The fuel jet 29 blown out from a fuel hole in the fuel nozzle 22 flows in an axial direction of the fuel nozzle 22 in FIG. 1. Also, the airflow 12 at an upstream end of the air nozzle plate 20 flows into the air nozzle 21 along a peripheral side of the fuel nozzle 22. A cylindrical hollow section provided in the air nozzle plate 20 constitutes the air nozzle 21. The airflow 12 that has flown into a very narrow space of the air nozzle 21 forms an annular layer at a peripheral side of the fuel jet 29. The fuel nozzle 22 and the air nozzle 21 are arranged so that fuel and air flow through the inside of the air nozzle 21 with the annular airflow 12 enfolding the peripheral side of the fuel jet 29 blown out from the fuel nozzle 22.

Inside the air nozzle, an obstacle 24 is disposed at an axial downstream side of the fuel nozzle 22, relative to the fuel hole in the fuel nozzle 22. Accordingly, the fuel jet 29 collides against the obstacle 24 and becomes diffused vertically with respect to a central axis of the fuel nozzle 22. That is to say, the fuel jet 29, after colliding against the disc-shaped obstacle 24, is diffused in a radial direction of a disc plane thereof. The “axial direction” in the present embodiment is a direction in which the fluids flow along the central axis of the fuel nozzle 22, and the “radial direction” is a radial direction relative to the disc plane of the obstacle.

The obstacle 24 also obstructs the flow of the airflow 12 and generates a very significant difference in velocity at a downstream region 44 formed at an edge of the obstacle. The obstacle 24 causes a strong turbulence 26 in the flow of the airflow 12 due to the difference in velocity.

At this time, since the fuel jet 29 is widely distributed outward in the radial direction, radial velocity components become small, so the fuel jet 29 is considered not to widely spread outward in the radial direction from the edge of the obstacle 24. For this reason, the fuel jet 29 is easily entrained in the region 44 that the turbulence occurs, and the fuel jet 29 is mixed with air.

A comparative example is described below using FIG. 29. This comparative example applies to a case in which the fuel nozzle has no obstacle at its downstream side and is ribbed at its tip. In the comparative example, the rib of the fuel nozzle tip can be utilized to generate the turbulence 26 of the airflow at the downstream side relative to the fuel nozzle tip. However, since the fuel jet 29 has a momentum and exhibits opposition to the turbulence 26 of the airflow, mixing between the fuel and the air is limited. Particularly in cases that a fuel-to-air ratio becomes too high locally under partial load conditions or that the fuel used is heavily laden with hydrogen or carbon monoxide and has a small calorific value per volume, insufficient fuel-air mixing results since the fuel jet penetrates the occurrence region of the turbulence 26.

The present embodiment can therefore attenuate the momentum of the fuel jet 29 significantly, regardless of a flow rate of the fuel, by causing a prior collision of the fuel jet 29 against the obstacle. In addition, fuel-air mixing is achievable by providing the obstacle in the air nozzle to cause the disturbance in the air flowing into the air nozzle. This, in turn, makes further fuel-air mixing achievable by introducing the momentum-attenuated fuel efficiently into the turbulence 26 of the airflow occurring at a downstream side of the obstacle.

In this manner, the fuel can be supplied to the turbulence 26 of the airflow having a significant difference in velocity, compared with that attainable in the comparative example, so an even greater mixing-acceleration effect can be obtained. It is also effective to increase typical length 32 of the obstacle to a size large enough for moderate blocking of the fuel jet, that is, a size equal to or greater than a fuel hole diameter 31 of the fuel nozzle. The fuel hole diameter 31 denotes a cross-sectional area of the fuel nozzle hollow region through which the fuel flows.

In addition to a natural gas consisting mainly of methane, the present embodiment is applicable to gas fuels heavily laden with hydrogen or carbon monoxide, such as a coal gasification gas and the coke oven gas (COG) occurring during purification processes at iron or steel works. Use of these fuels further enhances the above-described mixing acceleration effect, compared with that obtainable in the comparative example. Furthermore, the present embodiment is also effective for other fuels heavily laden with nitrogen or carbon dioxide and having a low calorific value per volume.

As described above, the present embodiment uses a gas fuel. Compared with liquid fuels, gas fuels are small in inertial force because of their low viscosities/densities. The gas fuel that has collided against the obstacle, therefore, flows towards the downstream side of the obstacle without colliding against an inner wall of the air nozzle 21. The fact that the gas fuel, after colliding against the obstacle, flows towards the downstream side of the obstacle without colliding against the inner wall of the air nozzle 21 means that the gas fuel flows through a very narrow region present along an outer edge of the obstacle.

Accordingly, since the obstacle is disposed in the air nozzle, turbulence of the airflow occurs at the downstream side along the outer edge of the obstacle. In the present embodiment, the turbulence 26 of the airflow and the region through which the gas fuel flows are substantially equal in size, such that mixing between the gas fuel and the air can be accelerated efficiently.

If, as shown in FIG. 1, the fuel nozzle tip is also present inside the air nozzle 21, the airflow 12 flowing around the fuel nozzle can be brought into a direct collision against the obstacle effectively by increasing the typical length 32 of the obstacle above an outside diameter 33 of the fuel nozzle tip. If the obstacle is of a circular shape, the typical length 32 of the obstacle denotes a diameter thereof. If the obstacle has a square shape, the typical length 32 of the obstacle denotes length of one side. A stronger turbulence 26 can be generated at the downstream side of the obstacle 24 by increasing the typical obstacle length 32 above the outside diameter 33 of the fuel nozzle tip. In addition to the cross-sectional area of the fuel nozzle hollow region through which the fuel flows, the outside diameter 33 of the fuel nozzle tip includes a cross-sectional area of the fuel nozzle pipe at a thick section thereof.

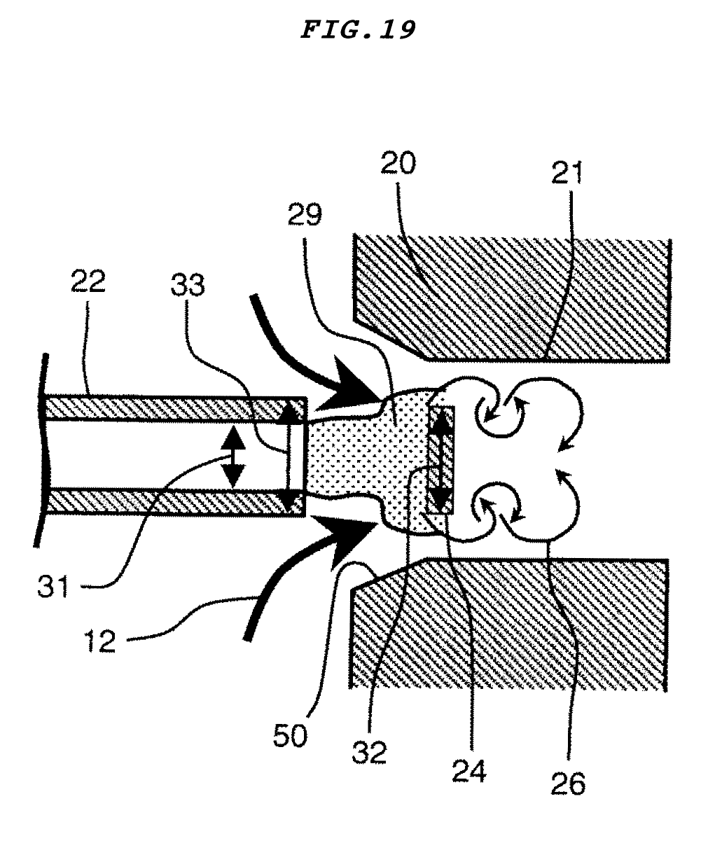

Conversely, if, as shown in FIG. 19, the tip of the fuel nozzle 22 is present outside the air nozzle 21, the typical length 32 of the obstacle can be small, compared with the outside diameter 33 of the fuel nozzle tip. Since the tip of the fuel nozzle 22 does not narrow an entrance area of the air nozzle 21, the airflow 12 directly collides against the obstacle 24 and can thus cause the strong turbulence 26 at the downstream side of the obstacle 24.

As shown in FIGS. 2 and 3, a support member 25 is provided to support the obstacle 24 and to interconnect the air nozzle 21 and the obstacle 24. The obstacle 24 in the present embodiment is of a circular disc shape, which distributes the turbulence 26 widely in annular form at the downstream side of the obstacle 24, allowing uniform mixing of the fuel and the air.

The support member 25 has a rectangular cross section as shown in FIG. 4. The support member itself also acts as a turbulence generator, generating turbulence 26 to assist the mixing of the air and the fuel. Thickness, however, is desirably suppressed to a level that does not affect strength, since an increased pressure loss will otherwise result.

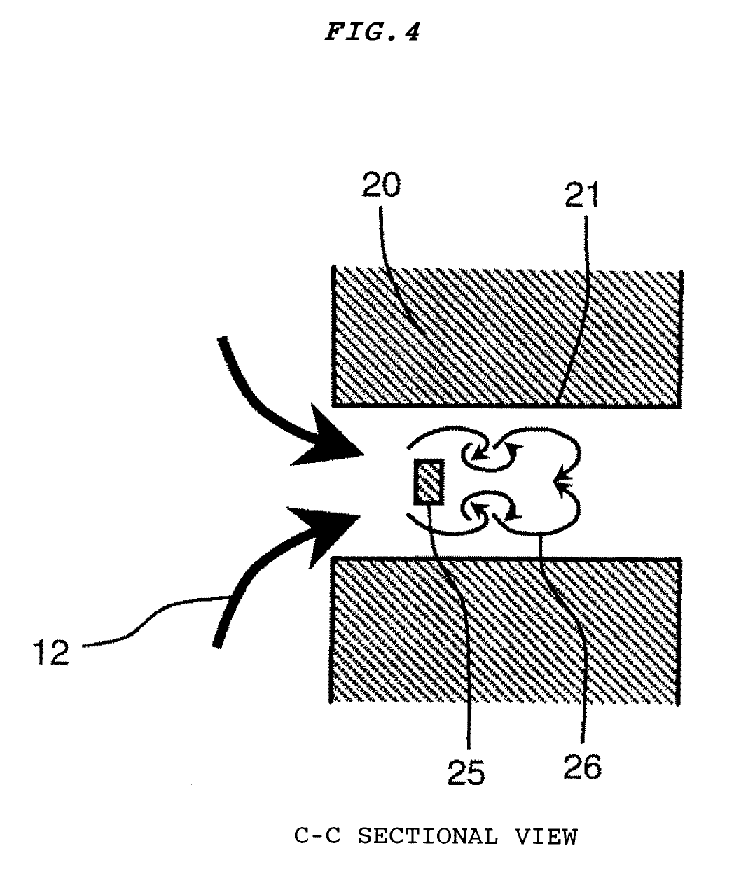

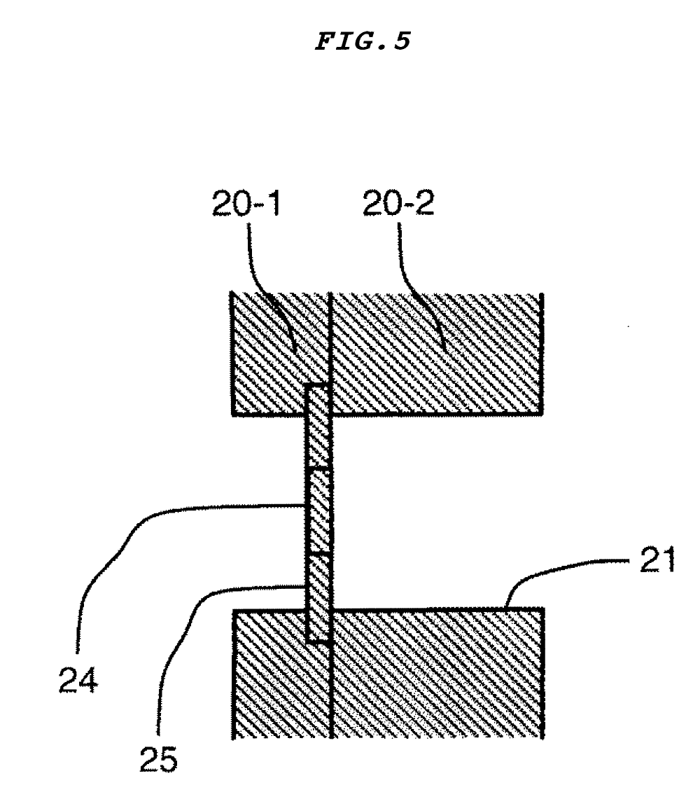

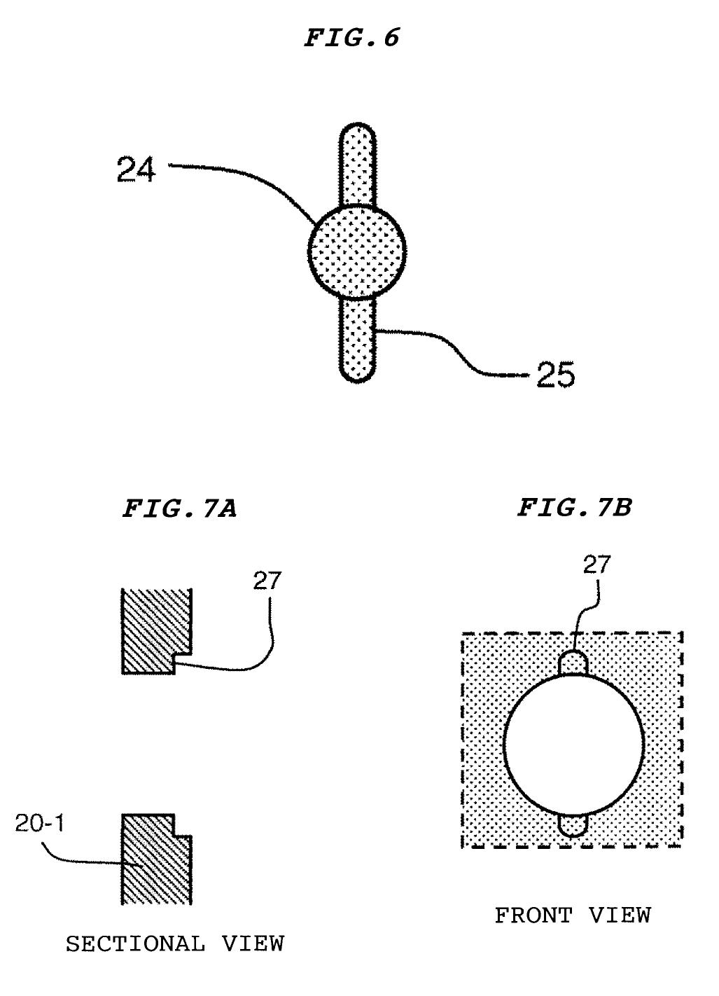

FIGS. 5, 6, 7A, and 7B show an example of fabricating the present embodiment. As shown in FIG. 5, two split members 20-1 and 20-2 are laminated together to fabricate the air nozzle plate 20. In addition, as shown in FIG. 6, the obstacle 24 and the support member 25 are created as an integrated component. As shown in FIGS. 7A and 7B, the air nozzle plate member 20-1 has a groove 27 for fitting the support member 25 thereinto. Imparting this construction to the support member allows the obstacle 24 to be disposed accurately in a central section of the air nozzle and thus a face of the obstacle 24 to be opposed vertically to the airflow. In this fabricating method, since a relationship in position between the air nozzle and the obstacle becomes easy to manage accurately, the amounts of air flowing into each air nozzle can be made constant. This, in turn, suppresses spatial variation of a fuel-air ratio in the chamber 1 and hence enables NOx reduction. Furthermore, the integrated component constituting the obstacle 24 and the support member 25 can be press-machined for mass production to reduce costs as shown in FIG. 6.

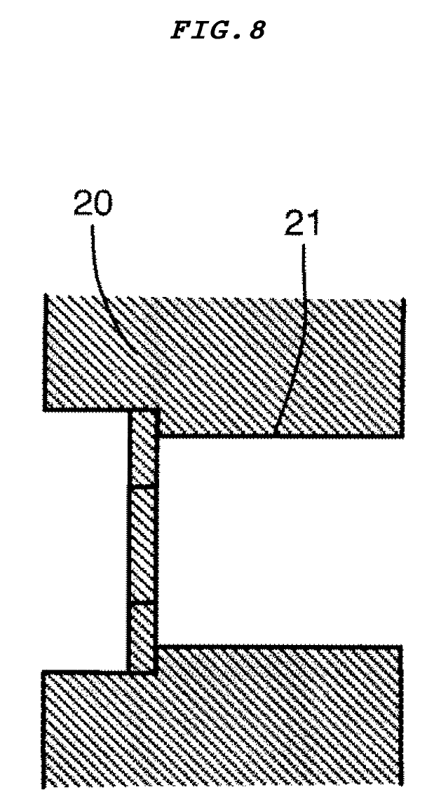

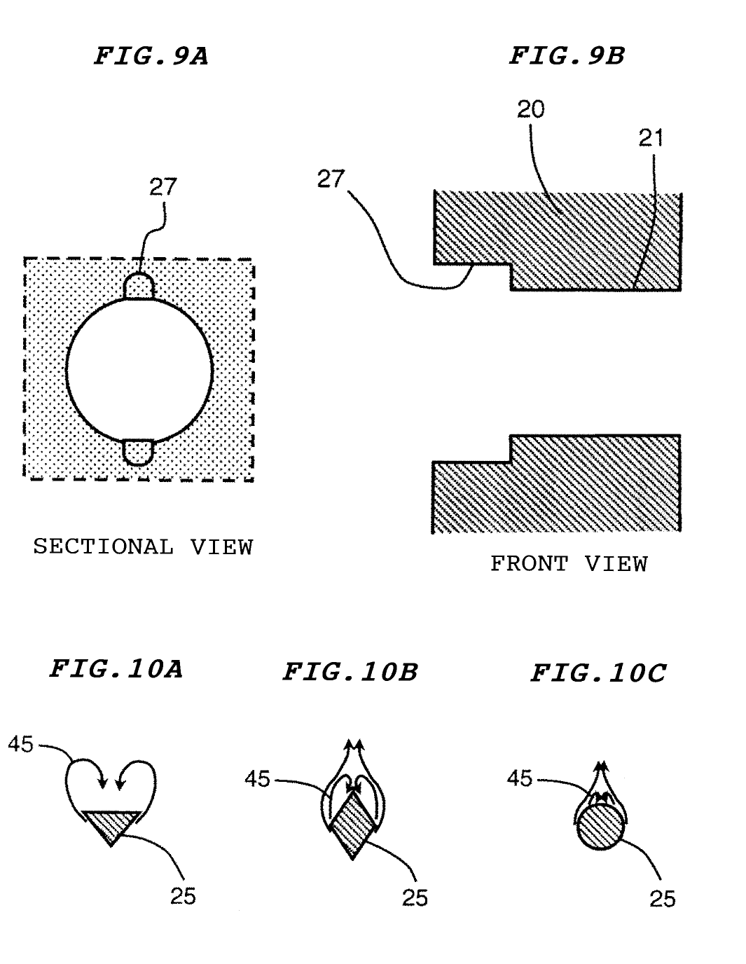

FIGS. 8, 9A, and 9B show another example of fabrication. In this example of fabrication, the obstacle 24 and the support member 25 are integrated as a single component similarly to the foregoing example of fabrication, except that since the air nozzle plate 20 is constructed using one plate, a groove 27 is formed that extends from an upstream end deeply relative to the air nozzle plate 20. As shown in FIG. 8, the integrated component constituting the obstacle 24 and the support member 25 is inserted into the groove 27 and secured thereto. This example of fabrication is effective in that the air nozzle plate requires no splitting.

FIGS. 10A, 10B, and 10C show variations on the cross-sectional shape of the support member 25. Referring to FIG. 10A, the support member has a triangular cross-sectional shape and is disposed so that an apex faces upstream. The triangular support member, as with the rectangular one, causes a flow separation 45 at a downstream end of the support member and hence, turbulence in the airflow. Compared with the rectangular one, the triangular support member creates a smooth flow at the upstream side and can thus slightly reduce any pressure loss.

The cross section of the support member 25 in FIG. 10B is rhomboid. The flow separation 45 caused at the downstream side is dimensionally suppressed in comparison with the rectangular or triangular ones and a pressure loss can be correspondingly reduced, so any pressure loss in the entire nozzle can be lessened.

The cross section of the support member 25 in FIG. 10C is circular. The flow separation 45 caused at the downstream side is dimensionally the smallest of all three forms described above, with any pressure loss being significantly suppressible.

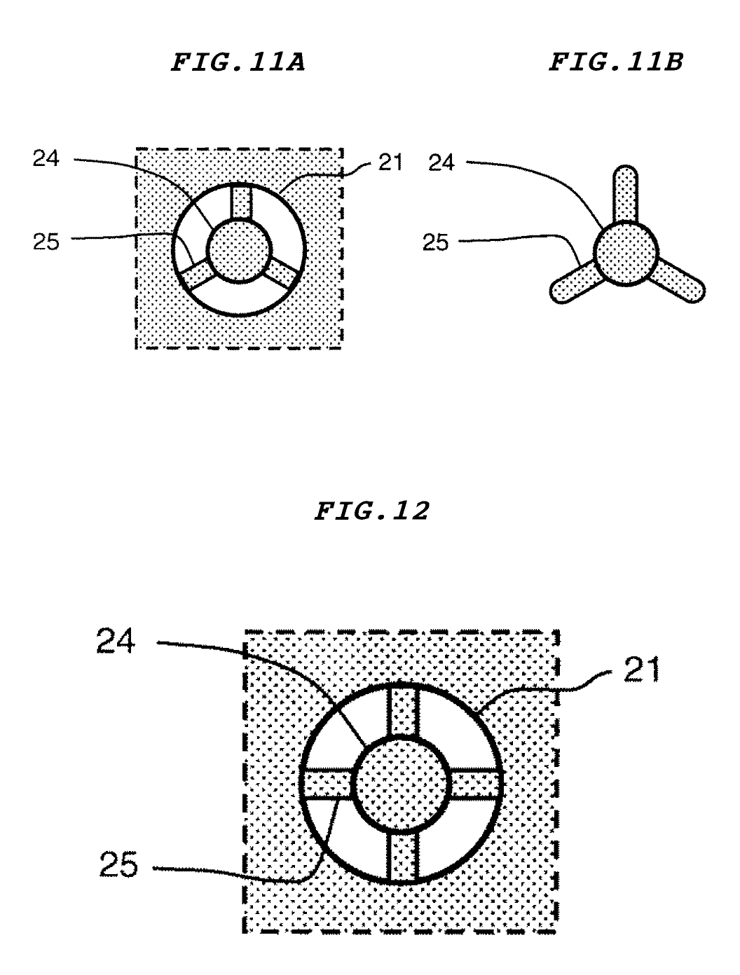

FIGS. 11A and 11B show a variation on the method of supporting the obstacle 24. Although the supporting methods hitherto described use two points to support the obstacle, this variation employs three-point support. This variation also assumes that as shown in FIG. 11B, the obstacle 24 and the support member 25 are constructed as an integrated component. Because of the three-point support of the support member in FIG. 11B, when the integrated component is mounted in the air nozzle 21 using any one of the fabricating methods shown in FIGS. 5 to 9A and 9B, the plane of the obstacle 24 is easy to dispose vertically with respect to the axial direction of the fuel nozzle.

FIG. 12 shows another variation on the method of supporting the obstacle 24. In this variation, the number of support points is further increased to four. As with three-point support, four-point support makes it easy to dispose the plane of the obstacle 24 vertically with respect to the axial direction of the fuel nozzle, and increases strength as well.

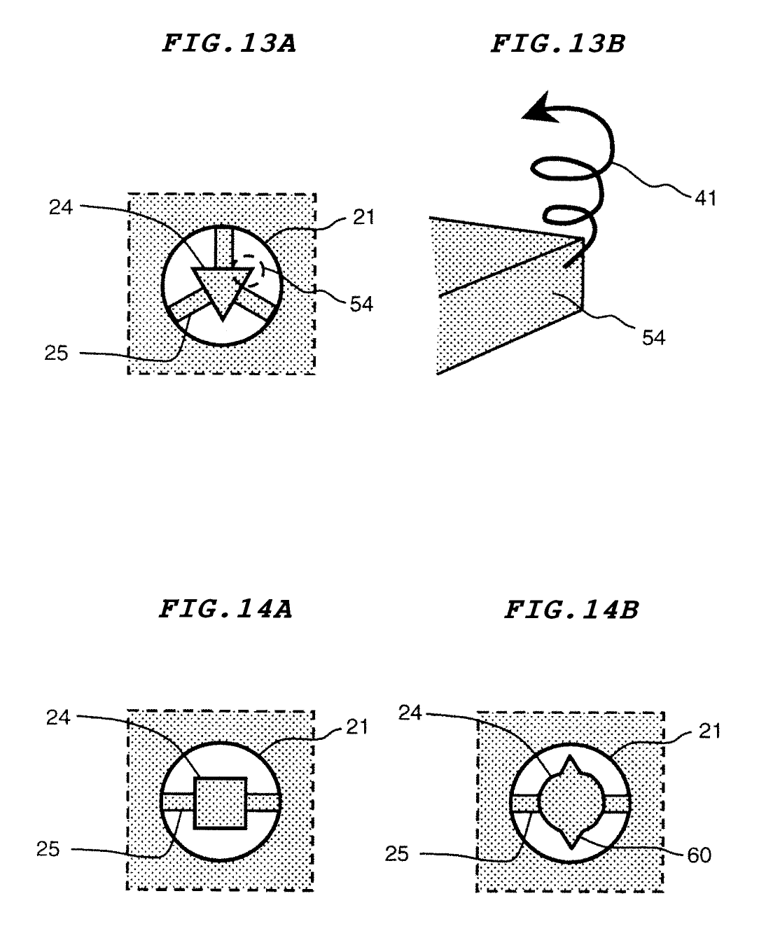

FIGS. 13A and 13B show a variation on the shape of the obstacle 24. The obstacle 24 in this variation has a triangular shape. In this shape, since a corner 54 protrudes towards the region through which air moves past, a longitudinal vortex 41 directed downstream from the corner 54 of the obstacle 24 is generated with the occurrence of turbulence due to the flow separation caused at the downstream side of the obstacle 24. The longitudinal vortex 41 causes a further turbulence, allowing the acceleration of fuel-air mixing. In general, however, longitudinal vortices have the characteristics that they are long in life and that they elude attenuation. Therefore, a triangular obstacle 24 is desirably applied to the air nozzle disposed at a distant position from a flame surface.

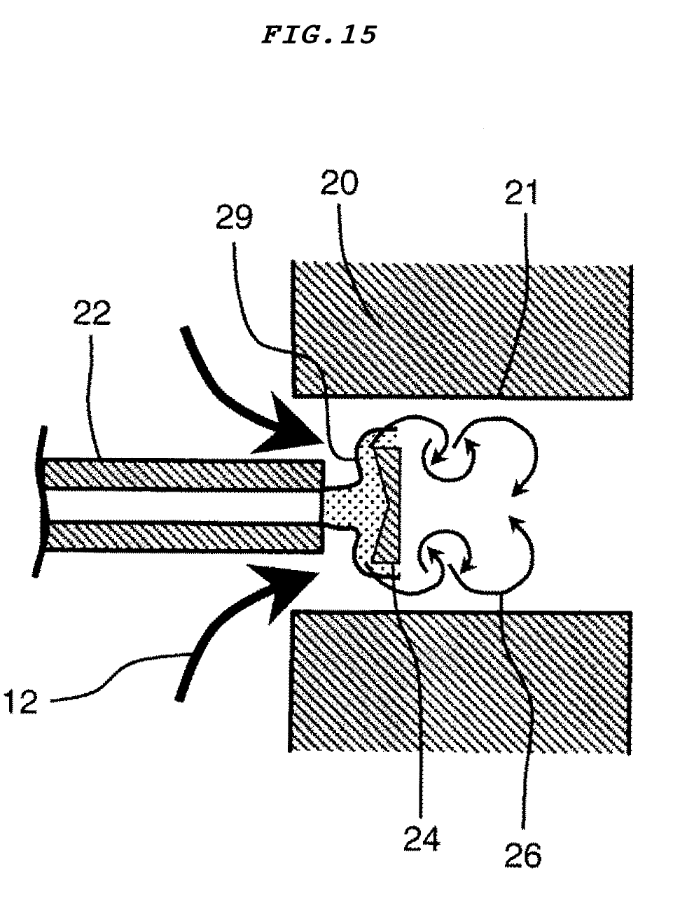

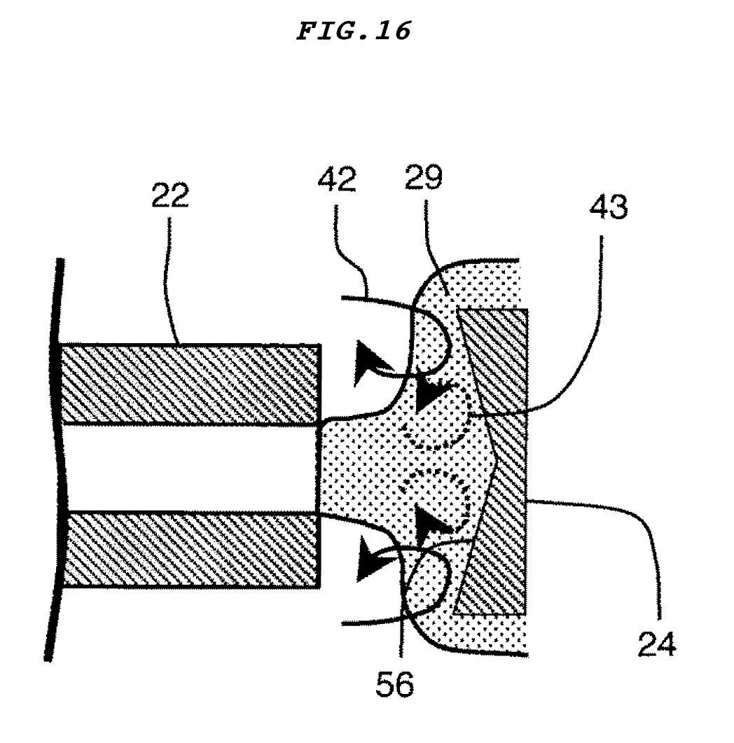

FIG. 14A shows another variation on the shape of the obstacle 24, as with FIGS. 13A and 13B. The obstacle 24 in this variation is of a square shape, having more corners 54 than in the variation of FIGS. 13A and 13B. This obstacle can therefore generate a longitudinal vortex at a larger number of positions. In addition, since an angle of the corners 54 is small, each longitudinal vortex generated is considered to weaken. Accordingly, if the longitudinal vortex can be attenuated prior to leaving the air nozzle, turbulences can be generated uniformly over the entire air nozzle interior.

Furthermore, a multi-cornered polygonal or starlike shape or any other shape having protrusions with respect to a flow channel for air also yields a similar effect. The shape shown in FIG. 14B, for example, is useable for the obstacle 24.

In the gas turbine combustor including plural combinations of such the fuel nozzle, air nozzle, and obstacle as described above, a fuel and air can be mixed at a very short distance and then supplied to the entire chamber 1 uniformly and homogenously. This allows combustion at a very low NOx emission level. Also, the combustor has stable mixing performance because of the fuel-air mixing state not depending upon the flow rate of the fuel. When the fuel-air ratio is high or a low-calorie fuel is used, therefore, deterioration of mixing characteristics can be suppressed, even if the flow rate of the fuel increases. In addition, when the fuel-air ratio is high or a low-calorie fuel is used, the fuel increases in blowout velocity and is distributed in a wide range upon collision against the obstacle. Accordingly, a boundary area between the fuel and the airflow is ensured sufficiently. Additionally, sufficient mixing occurs and NOx emissions can be reduced.

Since the present invention allows two fluids to be mixed at a very short distance, the invention can be used not only as a gas turbine combustor, but also as a mixer for mixing two fluids at a short distance or as other combustors.

The existing combustor described in JP-A-2003-148734 is convertible by replacing the combustor with that which employs the air nozzle plate of the present embodiment.

### Second Embodiment

A second embodiment is shown in FIG. 15. FIG. 16 is an enlarged view of the fuel nozzle tip and an obstacle. The shape of the obstacle in the present embodiment is changed from the shape shown and described in the first embodiment. The second embodiment is substantially the same as the first embodiment in that the obstacle 24 is disposed at the downstream side of the fuel nozzle, inside the air nozzle 21. A face of the obstacle 24, formed at the upstream side, is formed into a conical shape and has a recess 56. Forming this shape assigns to the fuel jet 29 a velocity vector of an inverse-directional component with respect to the blowout direction of the fuel jet 29 upon collision against the obstacle 24, and generates vortices 43 in the flow of the fuel. In addition, since the fuel jet blown out from the fuel nozzle 22 becomes significantly recessed along the recess 56 in the obstacle 24, a flow of air into the recess of the fuel jet generates vortices 42 at the airflow side as well. These vortices interfere with and strengthen one another, resulting in stronger turbulences, and mixing the fuel and the air. While maintaining the vortex components, the fuel jet 29 is acquired into a strong-turbulence generating region arising from an edge of the obstacle 24, and the air and the fuel are further mixed.

In this way, the present embodiment conducts a first mixing phase at the upstream side of the obstacle and can preassign turbulent components. Additionally, the embodiment conducts a second mixing phase at the downstream side of the obstacle and provides a further mixing acceleration effect.

Constructing a gas turbine combustor that includes a number of fuel nozzles and air nozzles according to the present embodiment, as in the first embodiment, makes combustion achievable at a very low NOx emission level, since a fuel and air can be mixed at a very short distance and since the fuel-air mixture can be supplied to the entire chamber 1 uniformly and homogenously.

### Third Embodiment

A third embodiment is shown in FIG. 18. The shapes of the air nozzle and fuel nozzle in the present embodiment are changed from the shapes shown and described in the first embodiment. As in the first embodiment, the obstacle 24 is disposed downstream with respect to the fuel nozzle 22, inside the air nozzle 21, and is positioned so that the fuel jet 29 collides against the obstacle 24.

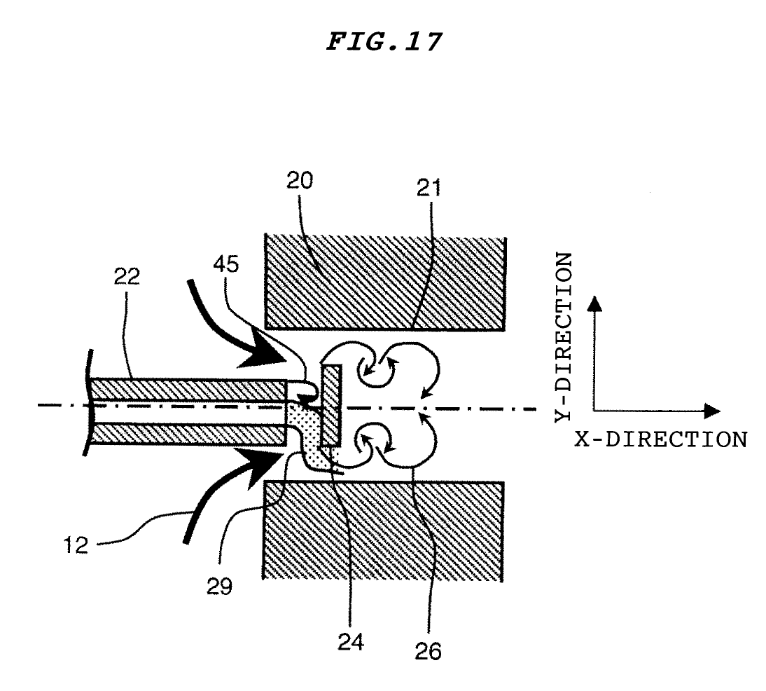

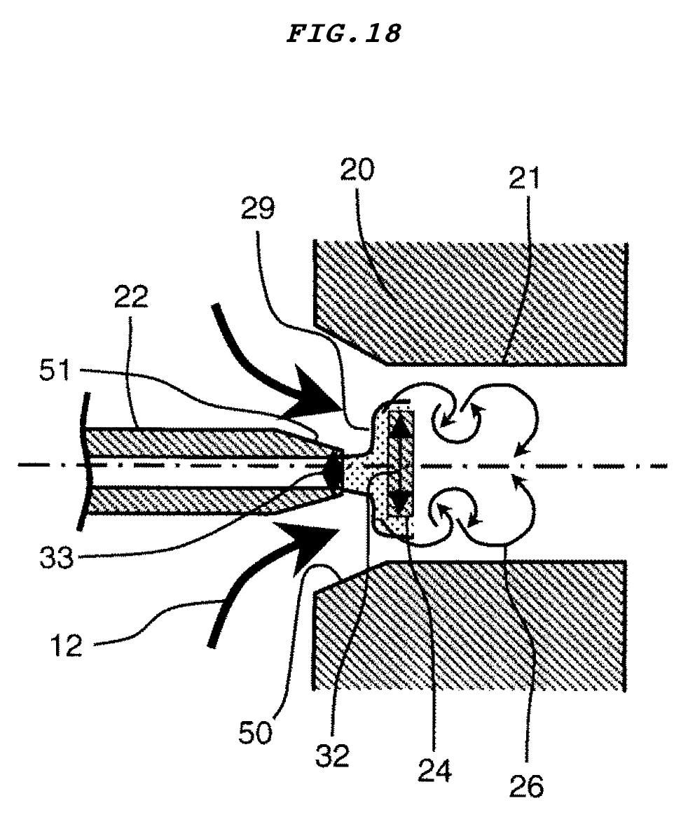

FIG. 17 shows a case in which the central axis of the fuel nozzle 22 in the first embodiment is shifted from central axes of the air nozzle 21 and the obstacle 24 significantly (decentered downward in a Y-direction. The flow of the airflow 12 into the air nozzle 21 is biased in such a case. Since the airflow 12 flows in great quantities into a wide-open end of the flow channel, a greater amount of air flows into an upper position of the Y-direction. This results in a significant flow separation 45 occurring near the tip of the fuel nozzle 22, at the upper position of the Y-direction.

Meanwhile, the fuel jet 29 blown out from the fuel nozzle 22 flows into a position that permits the jet to flow more easily and readily, such that a greater quantity of jet flows in an inverse direction relative to that of the strong flow separation 45 (i.e., downward in the Y-direction). This results in the distribution of the fuel being biased at the downstream side of the obstacle 24. In addition, the bias in the distribution of the fuel is liable to remain at an exit of the air nozzle 21. Continued combustion with the bias remaining unremoved causes a hot-flame region to occur locally, and resultingly increase NOx.

In the present embodiment, therefore, the air nozzle 21 has a taper 50 at its entrance, and the fuel nozzle 22 also has a taper 51 at its tip. Constructing the embodiment smoothens the flow of the airflow 12 existing at a time up to an arrival at the obstacle 24, and prevents the flow separation 45 in FIG. 17 from occurring at the tip of the fuel nozzle 22. As a result, any biases of the fuel distribution can be minimized, even if deviations occur between the central axes of the fuel nozzle 22, the air nozzle 21, and the obstacle 24. Increases in NOx emissions due to biases of the fuel distribution can therefore be suppressed.

To match the central axes of the fuel nozzle, the air nozzle, and the obstacle, machining accuracy of these members requires management during fabrication. Increases in NOx emissions due to mismatching between these central axes, however, can be minimized in the present embodiment. In addition, even if the machining accuracy of each member is lowered, costs can be reduced since NOx emissions can be suppressed with fuel-air mixing performance maintained.

### Fourth Embodiment

A fourth embodiment is shown in FIG. 19. The present embodiment with changes and conversions to the fuel nozzle and air nozzle shapes and fuel nozzle tip position in the first embodiment is effective for combustion, particularly of a fuel lower in calories and higher in flow rate.

A higher fuel flow rate increases the velocity in the fuel nozzle, and hence, a pressure loss. Accordingly, a need arises, for example, to increase an initial pressure of the fuel and introduce changes in valve specifications, and conducting these changes and conversions is liable to increase a total plant cost. To avoid increases in the cost, an inside diameter of the fuel nozzle needs to be increased for reduced velocity inside the nozzle. In the configuration of FIG. 1, thickening the fuel nozzle 22 results in the internal flow channel of the air nozzle 21 being blocked significantly. This, in turn, increases any pressure drops at the airflow side and reduces total gas turbine efficiency.

In addition, in a combination of the fuel nozzle and air nozzle according to the comparative example shown in FIG. 29, a rib 52 provided at the fuel nozzle tip generates turbulence in the airflow, thus prompting fuel-air mixing. However, if the tip of the fuel nozzle 22 is disposed upstream with respect to the entrance of the air nozzle 21 in order to avoid air nozzle blocking, periphery of the rib faces a wide space and reduces the air velocity at the periphery. Accordingly, the turbulence 26 stemming from the rib 52 is weakened to degrade the mixing acceleration effect.

In the present embodiment, therefore, a taper 50 is provided at the entrance of the air nozzle 21 and the tip of the fuel nozzle 22 is disposed upstream relative to the entrance of the air nozzle 21. The air nozzle plate 20 has the taper 50 at the entrance of the air nozzle 21 so that the cross-sectional area of the air flow channel gradually diminishes from the entrance, towards the downstream side. Thickening the fuel nozzle 22 does not block the flow channel of the air nozzle significantly.

Additionally, the obstacle 24 is disposed inside the air nozzle 21, air flows through a peripheral region of the obstacle 24 at high velocity, and thus a strong turbulence 26 occurs downstream with respect to the obstacle 24. For this reason, fuel-air mixing can be accelerated.

The fuel jet 29 collides against the obstacle 24 one time and loses the momentum. This prevents the mixing acceleration effect from being significantly limited by increases in the flow rate of the fuel. As described above, for a fuel having a low calorific value and increasing in flow rate, such as a hydrogen-rich fuel, the present embodiment can mix the fuel and air while at the same time suppressing any increases in the pressure loss of the fuel-air mixture.

The present embodiment has the taper 50 at the entrance of the air nozzle. However, provided that there is a margin on total combustor pressure loss and that a sufficient flow channel area is ensured between the fuel nozzle tip and the entrance of the air nozzle, there is no problem, even if the taper is not provided.

The present embodiment is effective for hydrogen-rich fuels, in particular. Hydrogen-rich fuels are very high in combustion rate and in a potential risk rate of backfire. For these reasons, diffusion combustors are used in gas turbines since use of a hydrogen-rich fuel in a gas turbine equipped with a premix combustor is liable to cause a backfire because of a long premixing distance. In the former case, the necessity of lowering the flame temperature by supplying a jet of nitrogen or water vapors to the chamber to suppress NOx emissions in the diffusion combustor could result in reduced total plant efficiency.

The potential risk rate of backfire in the configuration of the present embodiment is low since fuel and air can be mixed at a very short distance. In addition, NOx emissions can be suppressed without supplying a jet of nitrogen or water vapors to the chamber, such that highly reliable and highly efficient total plant operation can be implemented.

### Fifth Embodiment

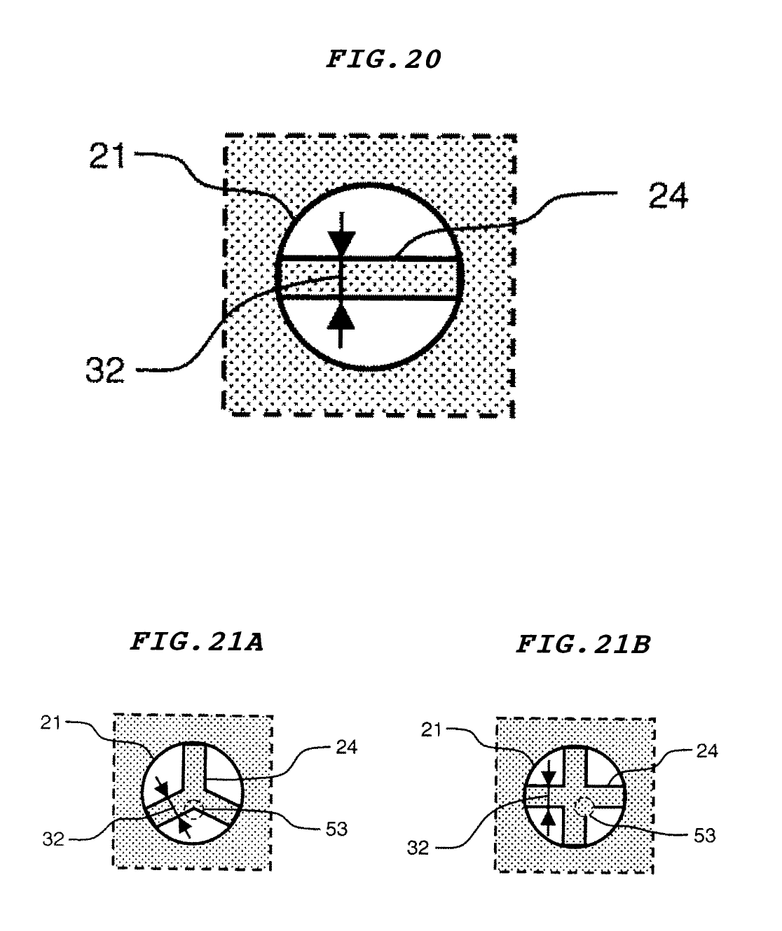

A fifth embodiment is shown in FIG. 20. The shape of the obstacle in the first embodiment is changed in the fifth embodiment. In the present embodiment, the obstacle 24 is an elongated plate and the obstacle itself has a support function. As in the first embodiment, the obstacle 24 is disposed in the air nozzle 21, downstream relative to the fuel nozzle 22, to establish the relationship in position that makes the fuel jet 29 collide against the obstacle 24. Since the obstacle 24 also functions to block the fuel jet 29 moderately and attenuate the momentum of the fuel, typical length 32 of the obstacle is preferably greater than the fuel hole diameter 31 of the fuel nozzle 22. The typical length 32 of the obstacle in the present embodiment is equivalent to plate width of the obstacle.

The turbulence 26 in the airflow occurs at the downstream side of the obstacle 24, and this turbulence accelerates fuel-air mixing. Simplifying the shape of the obstacle 24 in this way makes cost reduction achievable.

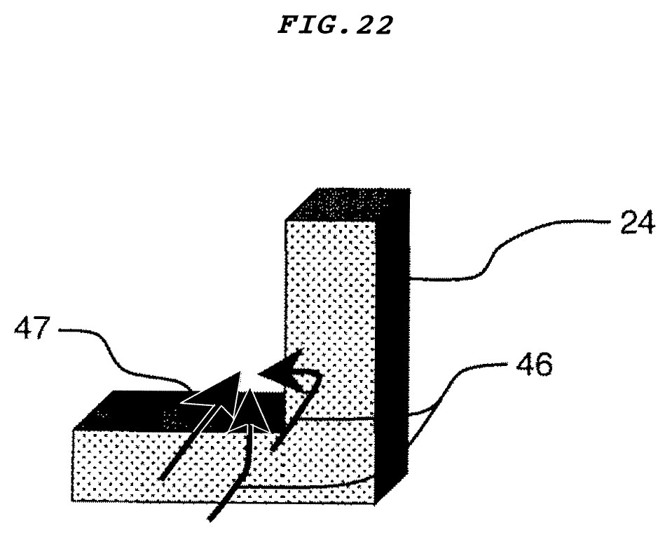

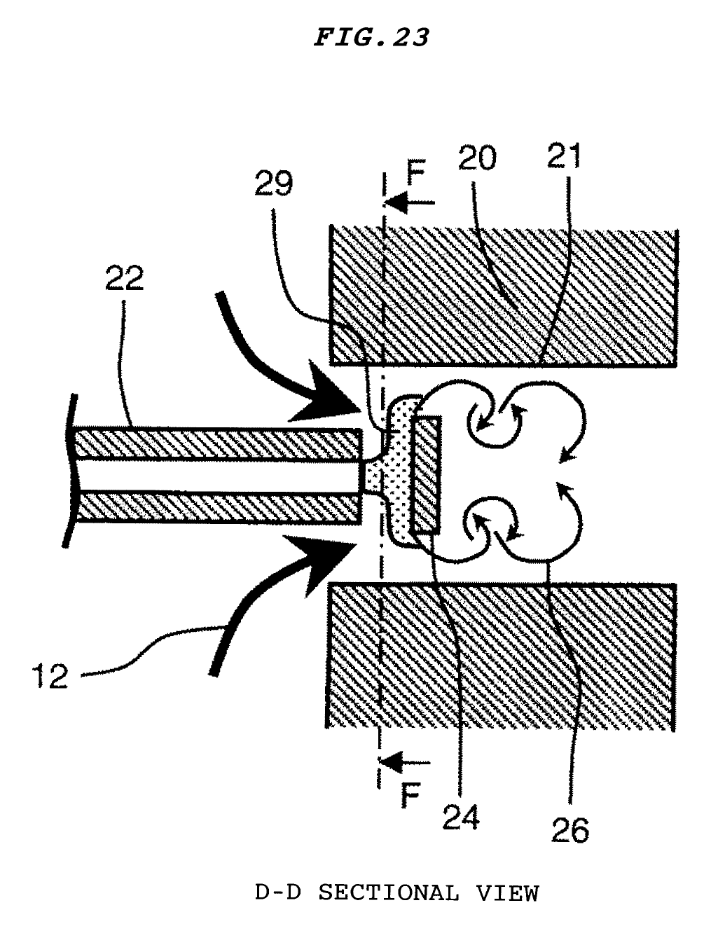

FIGS. 21A and 21B show further variations on the obstacle 24. These variations, unlike that of FIG. 20, include corners 53. As shown in the enlarged corner view of FIG. 22, intersection between an airflow 46 that collides against the obstacle 24 and changes in flow direction, and an airflow 47 that passes through intact, is considered to occur at the corner 53, thus cause a number of airflows of different flow directions to collide, and result in a strong turbulence. The fuel jet that has collided against the obstacle flows into the turbulence of the airflows, so the fuel and the air are mixed. In addition, an increase in the number of corners uniformizes the distribution of the fuel at the downstream side of the obstacle, and the uniformization is advantageous for fuel-air mixing.

### Sixth Embodiment

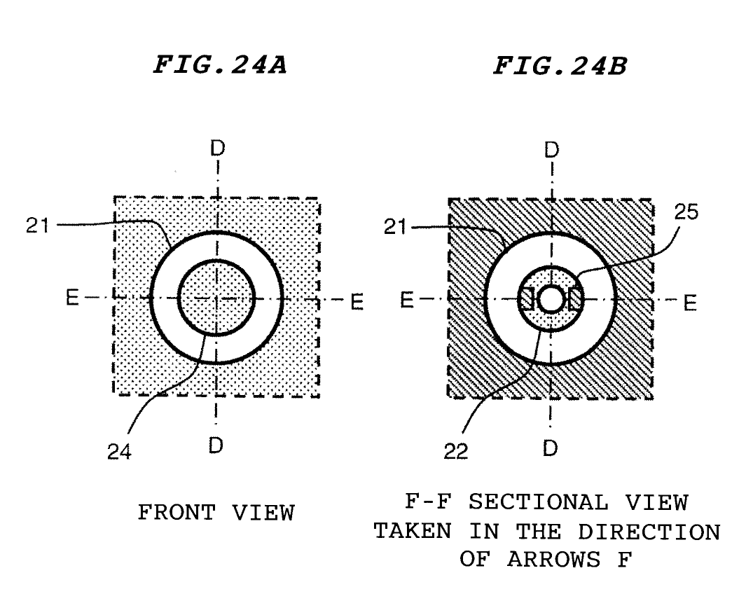

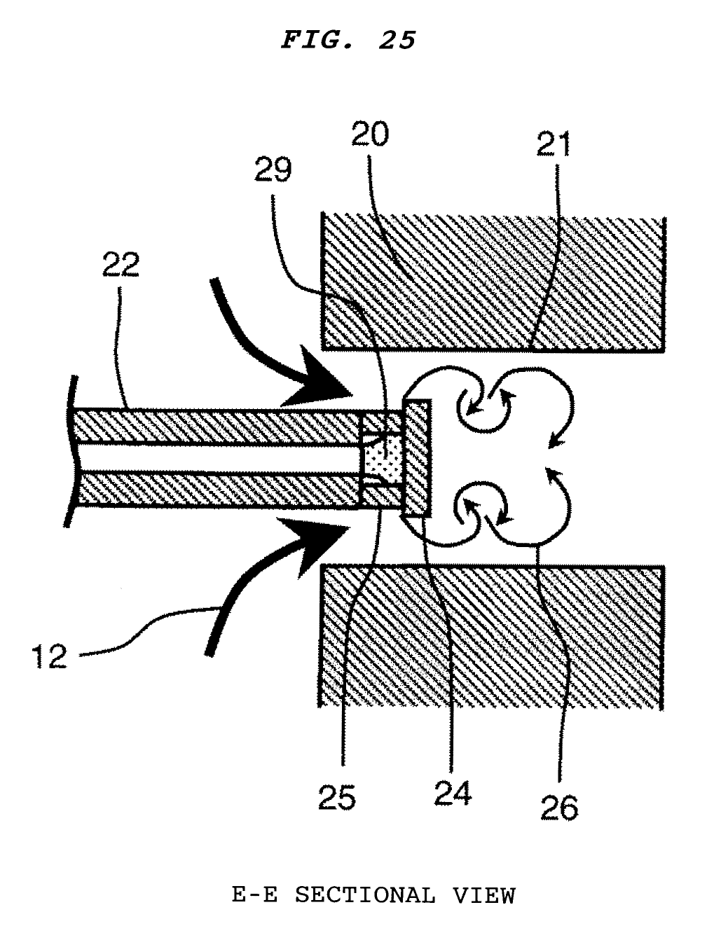

A sixth embodiment is shown in FIGS. 23 to 25. FIG. 23 is a sectional view of section D-D, FIGS. 24A and 24B are a front view and an sectional view taken in the direction of arrows F-F, and FIG. 25 is a sectional view of section E-E. In the present embodiment, as in the first embodiment, the obstacle 24 is disposed in the air nozzle 21, downstream relative to the fuel nozzle 22, to establish the relationship in position that makes the fuel jet 29 collide against the obstacle 24. In the first embodiment, the obstacle 24 is fixed to the air nozzle 21 by the support member 25. In the present embodiment, however, the obstacle 24 is fixed to the fuel nozzle 22 by the support member 25, as shown in FIG. 25.

The present embodiment has an advantage in that since the support member 25 does not block the flow channel within the air nozzle 21, increases in a pressure loss rate of the airflow side can be suppressed. The embodiment is also advantageous in that since the obstacle 24 is fixed to the fuel nozzle 22, it is easy to align both, that is, to match the central axes of the obstacle 24 and the fuel nozzle 22.

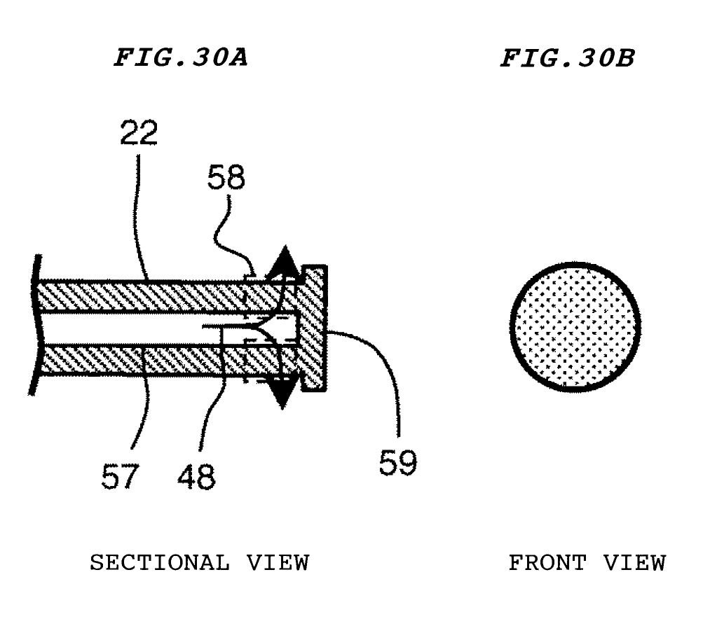

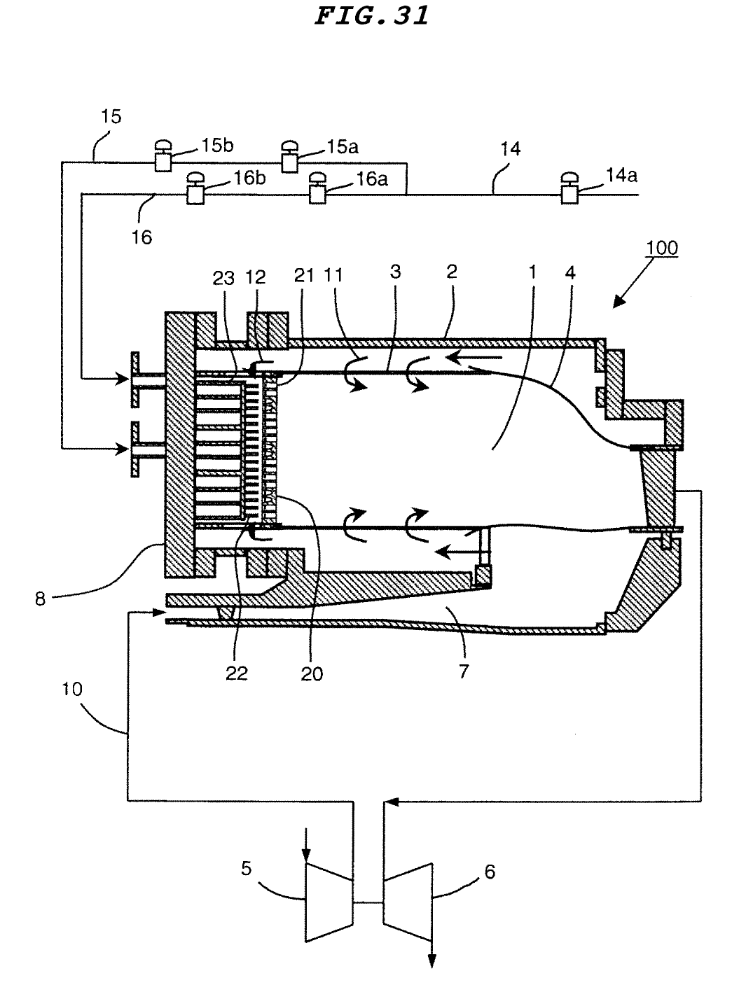

FIGS. 30A and 30B show an example of fabricating the present embodiment. For the fuel nozzle in the comparative example of FIG. 29, the internal flow channel 57 of the fuel jet extends through to the fuel nozzle tip. In this example of fabrication, however, as shown in FIG. 30, the internal flow channel 57 of the fuel jet does not extend through to the fuel nozzle tip 59. Only a portion of a region 58 is chipped off to serve as a support. The configuration with the obstacle disposed at the downstream side of the fuel nozzle tip can thus be obtained. The fuel nozzle tip 59 plays a role of the obstacle, and the fuel stream 48 flowing through the fuel nozzle 22 collides once at the fuel nozzle tip before becoming diffused widely over a surrounding downstream region. Adopting this fabricating method allows the fuel nozzle, the obstacle, and the support member to be integrally fabricated. In addition, machining such as aligning the fuel nozzle and the obstacle is easy to improve in accuracy, and the number of components required can be reduced.

The existing combustor described in JP-A-2003-148734 can be converted by replacing the combustor with that which employs the fuel nozzle of the present embodiment. More specifically, the conversion includes two steps. Firstly, the existing fuel nozzle is replaced with an obstacle-equipped fuel nozzle (equivalent to the fuel nozzle 22 in FIG. 23) that includes an obstacle for causing turbulence in the airflow flowing into the air nozzle, as well as for causing a collision of the fuel jet blown out from the fuel nozzle. Secondly, the relationship in position between the fuel nozzle and the air nozzle plate is adjusted so that the obstacle is positioned inside the air nozzle. Using this procedure makes even the existing combustor easily convertible and fuel-air mixing further accelerable without relying upon the flow rate of the

### Seventh Embodiment

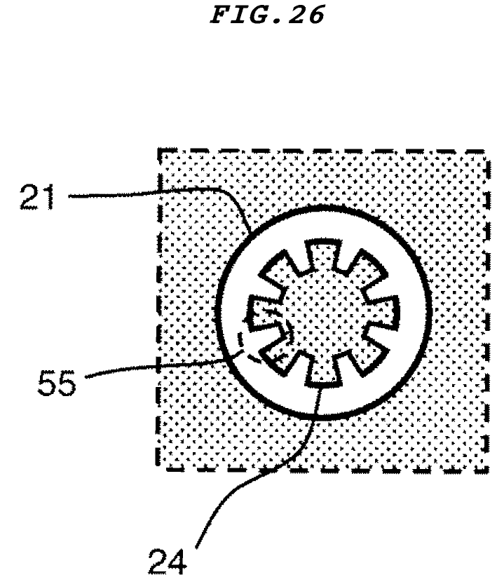

A seventh embodiment is shown in FIG. 26. FIG. 26 shows a front view of the air nozzle and the obstacle. In the present embodiment, as in the sixth embodiment, the obstacle 24 is set up downstream with respect to the fuel nozzle, the obstacle being disposed inside the air nozzle. Also, the obstacle 24 is fixed to the fuel nozzle by the support member. Whereas the obstacle in the sixth embodiment is a mere circular disc, the obstacle 24 in the present embodiment is a circular disc with a number of cuts 55.

In the present embodiment, as in the sixth embodiment, the fuel jet blown out from the fuel nozzle collides against the obstacle 24 and then spreads outward in the radial direction of the obstacle 24. Since an airflow that passes through the cuts 55, and an airflow that flows in after colliding against the obstacle 24 and changing in flow direction meet similarly to the event shown in FIG. 22, a vortex occurs at a boundary surface of the flows whose directions greatly differ from each other, and the vortex generates a strong turbulence. The fuel flows in there, so the fuel and the air can be mixed rapidly.

The shape of the obstacle 24 in the present embodiment is also effective for fixing the obstacle to the air nozzle side. Also, the shapes shown in FIGS. 13 and 14A, 14B are likewise effective for fixing the obstacle to the fuel nozzle.

### Eighth Embodiment

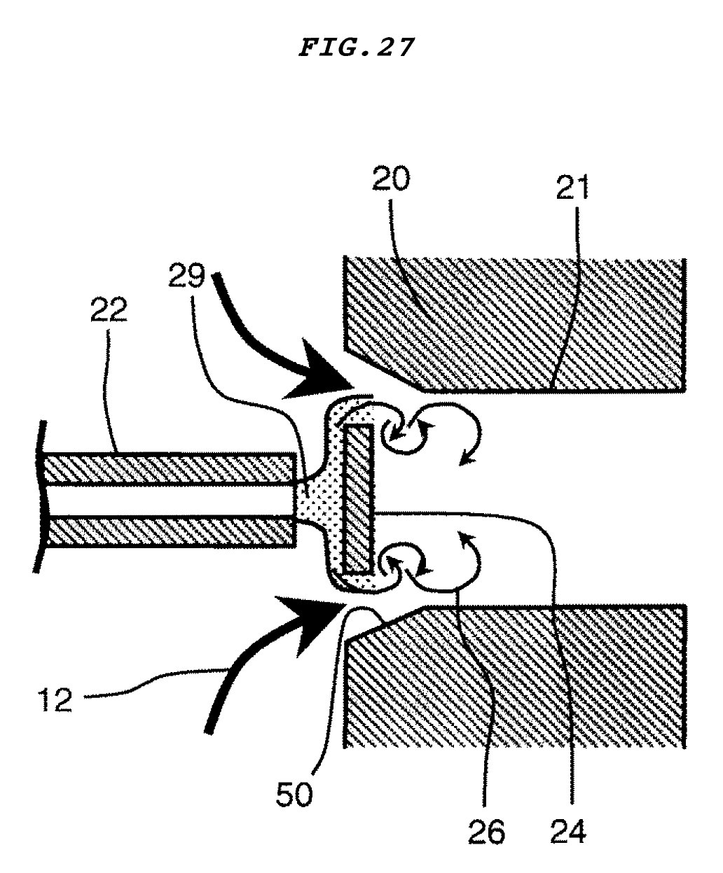

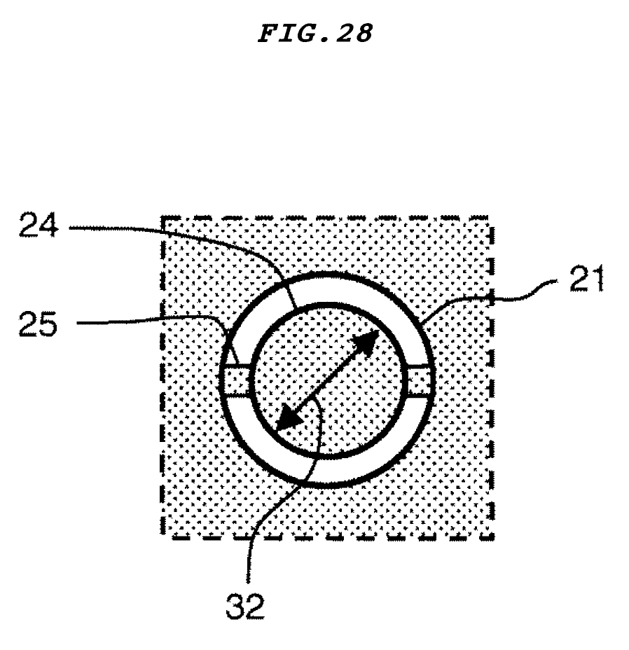

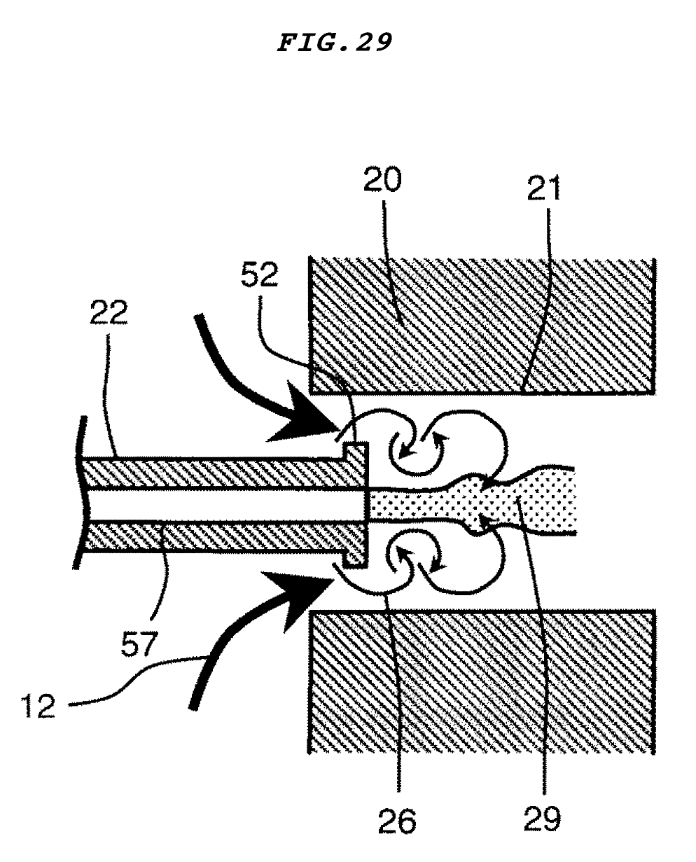

An eighth embodiment is shown in FIGS. 27 and 28. FIG. 27 is a sectional view showing the air nozzle, the fuel nozzle, and the obstacle. FIG. 28 is a front view of the air nozzle 21 as viewed from the combustion chamber side. In the present embodiment, as in the first embodiment, the obstacle is disposed downstream relative to the fuel nozzle and has the relationship in position that makes the fuel jet 29 collide against the obstacle. However, the present embodiment differs from the first embodiment in that the air nozzle 21 has a taper 50 and in that the obstacle 24 is disposed such that an upstream wall thereof is in proximity to a section of the entrance of the air nozzle 21. That is to say, the obstacle 24 is disposed at the entrance section having the largest airflow channel area of the air nozzle 21. Since the air nozzle 21 has the taper 50, an aperture area at the entrance section of the air nozzle 21 correspondingly increases. Because of this, even if the typical length 32 of the obstacle is increased, a sufficient airflow channel aperture area can be obtained and a pressure loss at the airflow side can be prevented from increasing. In addition, a fuel-air boundary area can be increased by dimensionally increasing the obstacle 24. This effect can be utilized to accelerate fuel-air mixing.

The groove 27 can be shallowed by fabricating the present embodiment using the method shown in FIGS. 8 and 9. This offers an advantage in that the obstacle and the support member can be easily connected to the air nozzle plate.

The air nozzle 21 has a wide sectional flow channel not only at the entrance of the air nozzle, but also anywhere else in a range of the taper 50. Accordingly, the obstacle 24 may be provided at an air nozzle spatial interval including the taper 50.

What is claimed is:

1. A gas turbine combustor comprising:
a fuel nozzle for blowing out a gas fuel;
an air nozzle plate with an air nozzle for jetting out the fuel and air into a combustion chamber after the blowout of the fuel from the fuel nozzle; and
an obstacle formed inside the air nozzle;
wherein the obstacle causes a collision of the fuel jet blown out from the fuel nozzle, and hence causes turbulence in an airflow streaming into the air nozzle.

2. The gas turbine combustor according to claim 1, wherein the obstacle is dimensionally greater than a fuel hole diameter of the fuel nozzle.

3. The combustor according to claim 1, wherein the obstacle is fixed to the air nozzle.

4. The combustor according to claim 1, wherein the obstacle is fixed to the fuel nozzle.

5. The combustor according to claim 1, further including a recess on a face at which the fuel jet collides against the obstacle.

6. The combustor according to claim 1, wherein a taper is provided at a tip of the fuel nozzle and also another taper is provided at an entrance of the air nozzle.

7. The combustor according to claim 1, wherein the obstacle has corner portions.

8. The combustor according to claim 1, wherein the obstacle has notches.

9. The combustor according to claim 1,
wherein the air nozzle has a taper formed at an entrance thereof; and
the obstacle is provided in a spatial interval of the air nozzle that includes the taper.

10. A method of supplying a fuel to a combustor comprising a fuel nozzle for blowing out a gas fuel; and an air nozzle plate with an air nozzle for jetting out the fuel and air into a combustion chamber after the blowout of the fuel from the fuel nozzle; the method comprising:
a first step in which the fuel, after being blown out from the fuel nozzle, collides against the obstacle disposed at a downstream side of the fuel nozzle and is then diffused outward in a radial direction of the obstacle;
a second step in which the air, after flowing into the air nozzle, collides against an outer edge of the obstacle and thus generates turbulence of the airflow at the downstream side of the obstacle; and
a third step in which to supply the fuel to the turbulence of the airflow, generated in the second step.

11. A method of fuel nozzle conversion in a combustor comprising a fuel nozzle for blowing out a gas fuel, and with an air nozzle plate including an air nozzle for jetting out the fuel and air into a combustion chamber after the blowout of the fuel from the fuel nozzle; the method comprising:
replacing an existing fuel nozzle with an obstacle-equipped fuel nozzle which has an obstacle for causing a collision of the fuel jet blown out from the fuel nozzle, and hence causing turbulence in an airflow streaming into the air nozzle; and
providing the obstacle-equipped fuel nozzle such that the obstacle is positioned inside the air nozzle.
